(19) United States
(12) Patent Application Publication
(10) Pub. No.: US 2016/0078177 A1
(43) Pub. Date: Mar. 17, 2016

(54) INFORMATION PROCESSING SYSTEM AND INFORMATION PROCESSING METHOD

(71) Applicant: Yusuke SUGIMOTO, Kanagawa (JP)

(72) Inventor: Yusuke SUGIMOTO, Kanagawa (JP)

(73) Assignee: Ricoh Company, Limited, Tokyo (JP)

(21) Appl. No.: 14/844,360

(22) Filed: Sep. 3, 2015

(30) Foreign Application Priority Data
Sep. 16, 2014 (JP) 2014-188293
Aug. 28, 2015 (JP) 2015-169687

(51) Int. Cl. G06F 19/00; G06Q 30/02

(52) U.S. Cl. CPC G06F 19/322; G06Q 30/0269; G06F 19/3431

(57) ABSTRACT

An information processing system includes: an input information acquiring unit that acquires input information including user information that includes user identification information for identifying a user, and medical data that indicates a state of health of the user; a registering unit that registers the user identified by the user identification information included in the input information as a target for providing a free first service; a first storage unit that stores therein the user information and the medical data in association with each other; a service providing unit that provides a second service utilizing the user information and the medical data to a business operator selling commodities concerning health or providing services concerning health; and a consideration acquiring unit that acquires a consideration for the second service from the business operator.

### CROSS-REFERENCE TO RELATED APPLICATIONS

The present application claims priority to and incorporates by reference the entire contents of Japanese Patent Application No. 2014-188293 filed in Japan on Sep. 16, 2014 and Japanese Patent Application No. 2015-169687 filed in Japan on Aug. 28, 2015.

### BACKGROUND OF THE INVENTION

1. Field of the Invention

The present invention relates to an information processing system and an information processing method.

2. Description of the Related Art

The conventional technology has been known for separately collecting, storing, and analyzing various types of medical data. Such medical data includes information indicating a result of a medical check-up, information indicating a medical certificate written by a doctor, information indicating a case history of a person, information indicating a case history of members of the person's family, information indicating hospital records of the person, information indicating a medication history of the person, information indicating a receipt serving as a health insurance claim form, and vital information including the blood pressure, weight, and height of the person.

For example, Japanese Laid-open Patent Publication No. 2004-185547 discloses a technique for extracting the relation of data as a basis of a diagnosis from medical data.

However, free provision of medical data of a person that is private information of the person is highly likely to be refused. If medical data is acquired in exchange for the consideration, the cost is too expensive. Accordingly, there has been a problem in that efficiently collecting a sufficient amount of medical data with lower cost is difficult.

### SUMMARY OF THE INVENTION

It is an object of the present invention to at least partially solve the problems in the conventional technology.

An information processing system includes: an input information acquiring unit that acquires input information including user information that includes user identification information for identifying a user, and medical data that indicates a state of health of the user; a registering unit that registers the user identified by the user identification information included in the input information as a target for providing a free first service; a first storage unit that stores therein the user information and the medical data in association with each other; a service providing unit that provides a second service utilizing the user information and the medical data to a business operator selling commodities concerning health or providing services concerning health; and a consideration acquiring unit that acquires a consideration for the second service from the business operator.

An information processing system includes: an input information acquiring unit that acquires input information including user information that includes user identification information for identifying a user, and medical data that indicates a state of health of the user; a registering unit that registers the user identified by the user identification information included in the input information as a target for providing a first service with a benefit; a first storage unit that stores the user information and the medical data in association with each other; a service providing unit that provides a second service utilizing the user information and the medical data to a business operator selling commodities concerning health or providing services concerning health; and a consideration acquiring unit that acquires a consideration for the second service from the business operator.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining the outline of a business model according to an embodiment of the present invention;

FIG. 2 is a diagram illustrating an example of the configuration of a system according to the embodiment;

FIG. 3 is a block diagram illustrating an example of the functional configuration of an information processing system according to the embodiment;

FIG. 4 is a diagram illustrating an example of the hardware configuration of an information processing portion;

FIG. 5 is a diagram illustrating an example of user information;

FIG. 6 is a diagram illustrating an example of information stored in a user information storage unit;

FIG. 7 is a diagram illustrating an example of information stored in a medical data storage unit;

FIG. 8 is a block diagram illustrating an example of the functional configuration of an information processing system according to a modification of the embodiment;

FIG. 9 is a diagram illustrating an example of information stored in a medical data storage unit;

FIG. 10 is a diagram illustrating an example of information stored in an advertisement distribution conditions storage unit;

FIG. 11 is a diagram illustrating an example of information stored in an advertising data storage unit;

FIG. 12 is a diagram illustrating an example of an advertisement distributed to a user by e-mail; and

FIG. 13 is a flowchart illustrating an example of operations of the information processing system.

### DETAILED DESCRIPTION OF THE PREFERRED EMBODIMENTS

Hereinafter, an information processing system and an information processing method according to an embodiment of the present invention will be described in detail with reference to the accompanying drawings.

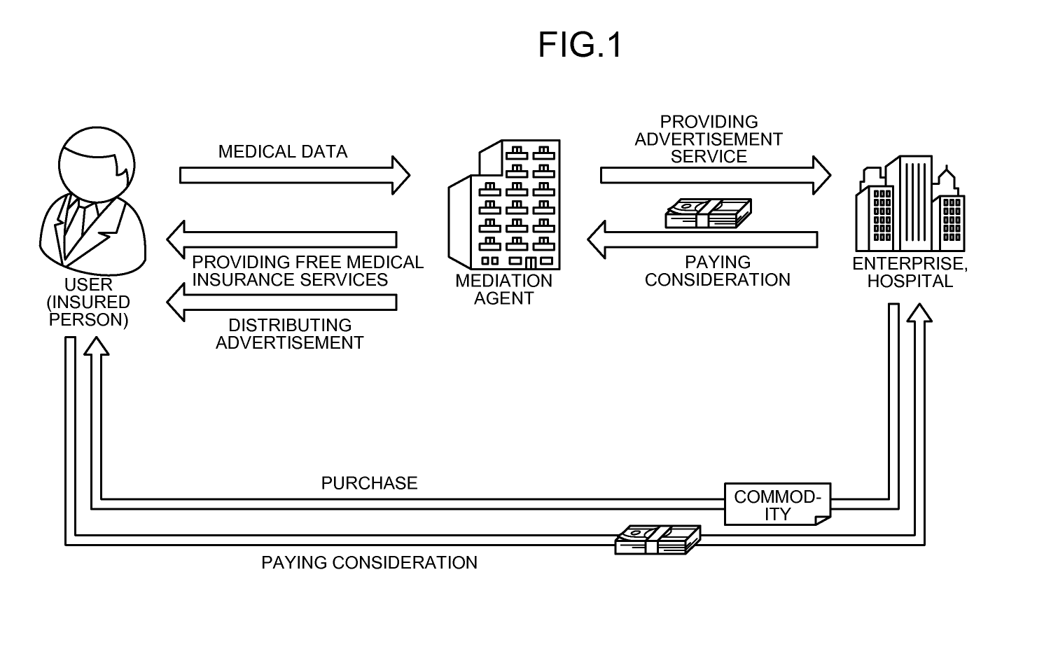

FIG. 1 is a diagram for explaining the outline of a business model achieved according to the present embodiment. A user (an insured person) who has agreed with provision of its own medical data under the condition that the user can be provided with free medical insurance services (in this example, corresponding to a “first service” in claims herein, but not limited thereto) periodically (e.g., every year) provides a mediation agent with its own medical data. The mediation agent evaluates the medical data of each user and determines the insurance amount depending on the difference of the probability of occurrence of a disease (the level of risk). As will be described in detail later, the mediation agent acquires user information including a user ID (user identification information) for identifying a user together with the medical data. The user ID corresponds to “user identification information” in the claims.

Here, the medical data includes at least one of the information indicating a result of a medical check-up, the information indicating a medical certificate written by a doctor, the information indicating a case history of a person, the information indicating a case history of members of the person's family, the information indicating hospital records of the person, the information indicating a medication history of the person, the information indicating a receipt serving as a health insurance claim form, and vital information (vital data) including the blood pressure, weight, and height of the person. The medical insurance services herein refer to services in which an insured person is paid at least a part of medical expenses incurred on receiving its medical examination in a medical institution.

The mediation agent provides a business operator selling commodities concerning health or providing services concerning health (in the example illustrated in FIG. 1, an enterprise or a hospital) with an advertisement service (in this example, corresponding to a “second service” in claims herein, but not limited thereto) for distributing the advertisement of commodities sold or services provided by the business operator to a user (an insured person) by utilizing the acquired user information and medical data, and acquires the consideration from the business operator. Examples of commodities concerning health include products concerning health such as supplements, bath agents, and massagers. Examples of services concerning health include information on solicitation to join a gym and on application to a gym, and information on a comprehensive medical examination or a medical check-up service and information on application thereto. In the example illustrated in FIG. 1, if a user who has viewed the advertisement purchases a commodity targeted for the advertisement, the business operator pays a part of the sales amount of the commodity as the consideration for the advertisement service. This manner of payment is described merely for exemplary purpose and not limiting. For another example, the payment may be done in such a manner that if a user who has viewed the advertisement participates an explanatory meeting of a commodity or a service targeted for the advertisement, the business operator pays a certain amount determined in advance as the consideration for the advertisement service to the mediation agent.

The mediation agent aims to collect a sufficient amount of the medical data that is private information of a person with lower cost and with high efficiency. Free provision of medical data of a person that is private information of the person is highly likely to be refused. The mediation agent therefore provides a user (an insured person) with free medical insurance services in exchange for the medical data of the user, thereby allowing a sufficient amount of the medical data to be collected. The mediation agent also provides a business operator with an advertisement service for distributing the advertisement of commodities sold or services provided by the business operator to the user by utilizing the collected medical data, and acquires the consideration from the business operator, thereby allowing the cost of the medical insurance services to be covered. This operation can collect a sufficient amount of the medical data with lower cost and with high efficiency.

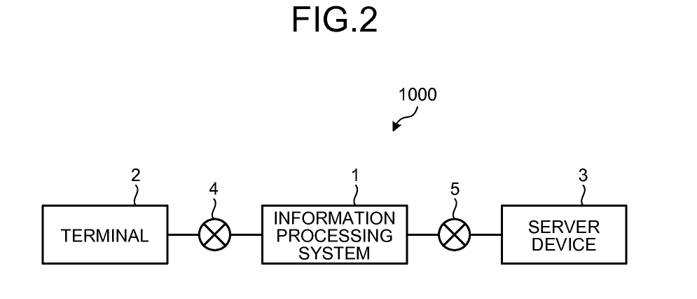

FIG. 2 is a diagram illustrating an example of the configuration of a system 1000 according to the embodiment. As illustrated in FIG. 2, the system 1000 according to the present embodiment includes a terminal 2 used by a user (an insured person), an information processing system 1 owned by a mediation agent, and a server device 3 used by a business operator (an advertiser). In the example illustrated in FIG. 2, the terminal 2 is coupled to the information processing system 1 through a first network 4, and the server device 3 is coupled to the information processing system 1 through a second network 5. The first network 4 and the second network 5 may be an identical network or different networks. The number of units of each of the terminal 2 and the server device 3 may be arbitrary, and is not limited to one unit.

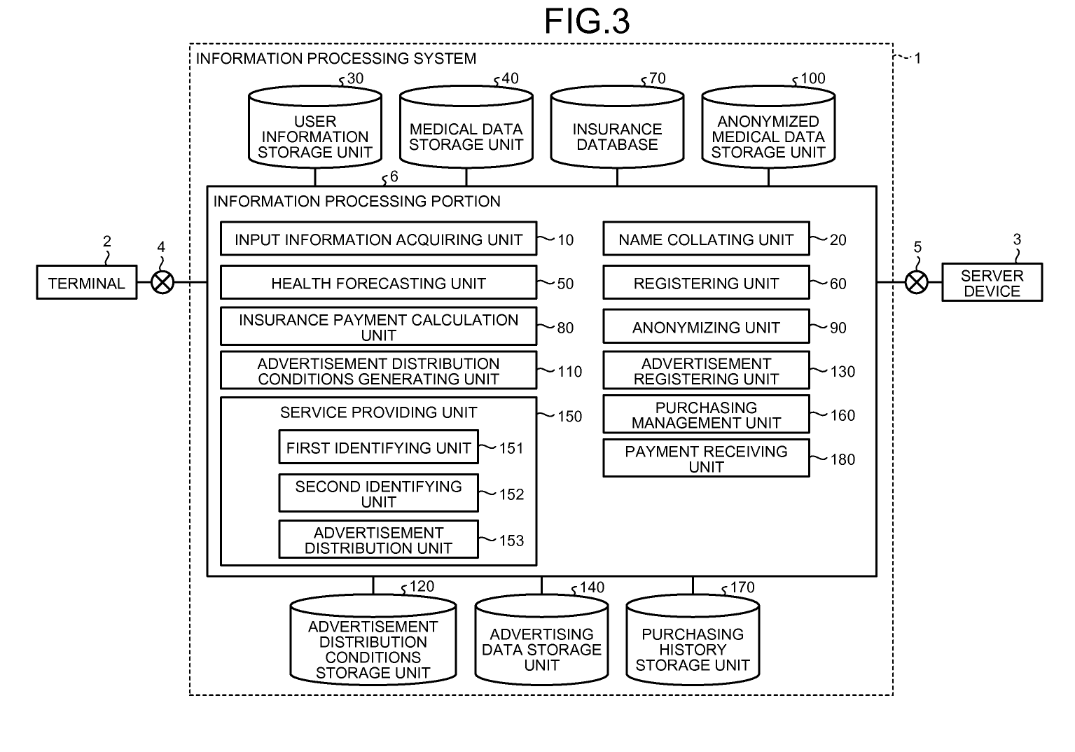

The following mainly describes the information processing system 1 owned by the mediation agent. FIG. 3 is a block diagram illustrating an example of the functional configuration of the information processing system 1. As illustrated in FIG. 3, the information processing system 1 includes an information processing portion 6, a user information storage unit 30, a medical data storage unit 40, an insurance database 70, an anonymized medical data storage unit 100, an advertisement distribution conditions storage unit 120, an advertising data storage unit 140, and a purchasing history storage unit 170.

In this example, the information processing portion 6 is directly coupled to each of the user information storage unit 30, the medical data storage unit 40, the insurance database 70, the anonymized medical data storage unit 100, the advertisement distribution conditions storage unit 120, the advertising data storage unit 140, and the purchasing history storage unit 170. Also in this example, the terminal 2 and the server device 3 are set so as to be unable to access the user information storage unit 30, the medical data storage unit 40, the insurance database 70, the anonymized medical data storage unit 100, the advertisement distribution conditions storage unit 120, the advertising data storage unit 140, and the purchasing history storage unit 170 therethrough (a firewall or the like is set, for example).

As illustrated in FIG. 3, the information processing portion 6 includes an input information acquiring unit 10, a name collating unit 20, a health forecasting unit 50, a registering unit 60, an insurance payment calculation unit 80, an anonymizing unit 90, an advertisement distribution conditions generating unit 110, an advertisement registering unit 130, a service providing unit 150, a purchasing management unit 160, and a payment receiving unit 180.

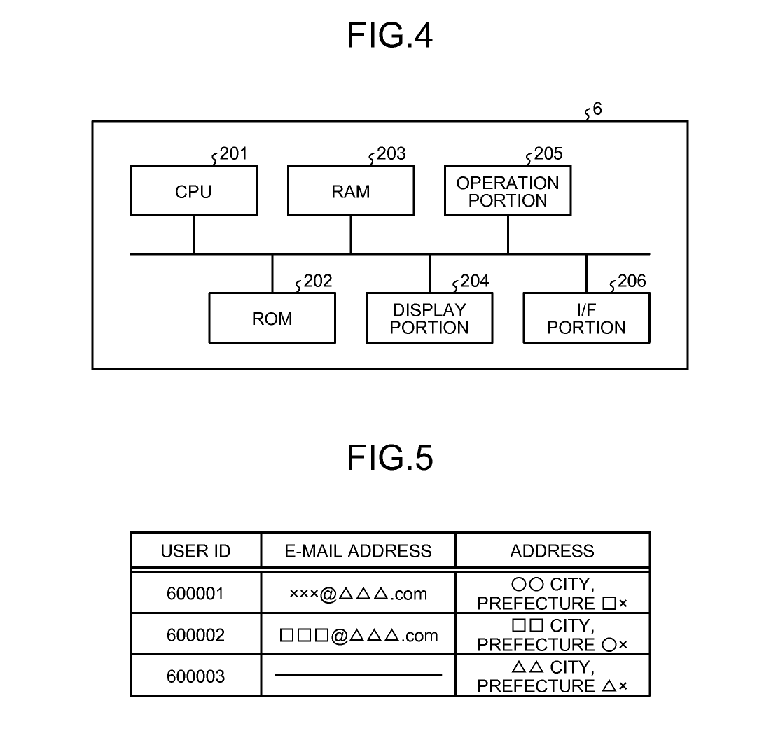

FIG. 4 is a diagram illustrating an example of the hardware configuration of the information processing portion 6. In this example, the information processing portion 6 is constituted of one computer device and includes a central processing unit (CPU) 201, a read-only memory (ROM) 202, a random-access memory (RAM) 203, a display portion 204, an operation portion 205, and an interface portion 206. The CPU 201 integrally controls operations of the information processing portion 6. The ROM 202 is a non-volatile memory that stores therein various types of data such as a computer program. The RAM 203 is a volatile memory that functions as a working area for the CPU 201. The display portion 204 is a device that displays thereon various types of information and can be constituted of a liquid crystal display, for example. The operation portion 205 is a device used for various types of operations and can be constituted of a keyboard or a mouse, for example. The interface portion 206 is an interface used for coupling the information processing portion 6 to an external device.

In this example, the terminal 2 and the server device 3 each have the hardware configuration same as that illustrated in FIG. 4.

In the present embodiment, the functions of the above-described components, that is, the input information acquiring unit 10, the name collating unit 20, the health forecasting unit 50, the registering unit 60, the insurance payment calculation unit 80, the anonymizing unit 90, the advertisement distribution conditions generating unit 110, the advertisement registering unit 130, the service providing unit 150, and the purchasing management unit 160, and the payment receiving unit 180 are achieved by the CPU 201 executing a computer program stored in the ROM 202 and the like. This configuration is provided merely for exemplary purpose and not limiting. At least a part of the functions of the above-described components, that is, the input information acquiring unit 10, the name collating unit 20, the health forecasting unit 50, the registering unit 60, the insurance payment calculation unit 80, the anonymizing unit 90, the advertisement distribution conditions generating unit 110, the advertisement registering unit 130, the service providing unit 150, the purchasing management unit 160, and the payment receiving unit 180 may be achieved with an exclusive hardware circuitry (e.g., a semiconductor integrated circuit).

In addition, the information processing portion 6 may be constituted of a plurality of computer devices, for example. Accordingly, the functions of the above-described components, that is, the input information acquiring unit 10, the name collating unit 20, the health forecasting unit 50, the registering unit 60, the insurance payment calculation unit 80, the anonymizing unit 90, the advertisement distribution conditions generating unit 110, the advertisement registering unit 130, the service providing unit 150, the purchasing management unit 160, and the payment receiving unit 180 may be arbitrarily divided into components in the computer devices.

With reference to FIG. 3 again, the following describes the functions of components included in the information processing system 1. The input information acquiring unit 30 acquires (receives) input information that includes user information including a user ID for identifying a user (an insured person) who has agreed with provision of its own medical data under the condition that the user can be provided with free medical insurance services, and medical data indicating the state of health of the user, from the terminal 2 used by the user through the first network 4. FIG. 5 is a diagram illustrating an example of user information. As illustrated in FIG. 5, the user information includes a user ID, an e-mail address on the terminal 2, and an address of the user. The user information may not include the e-mail address.

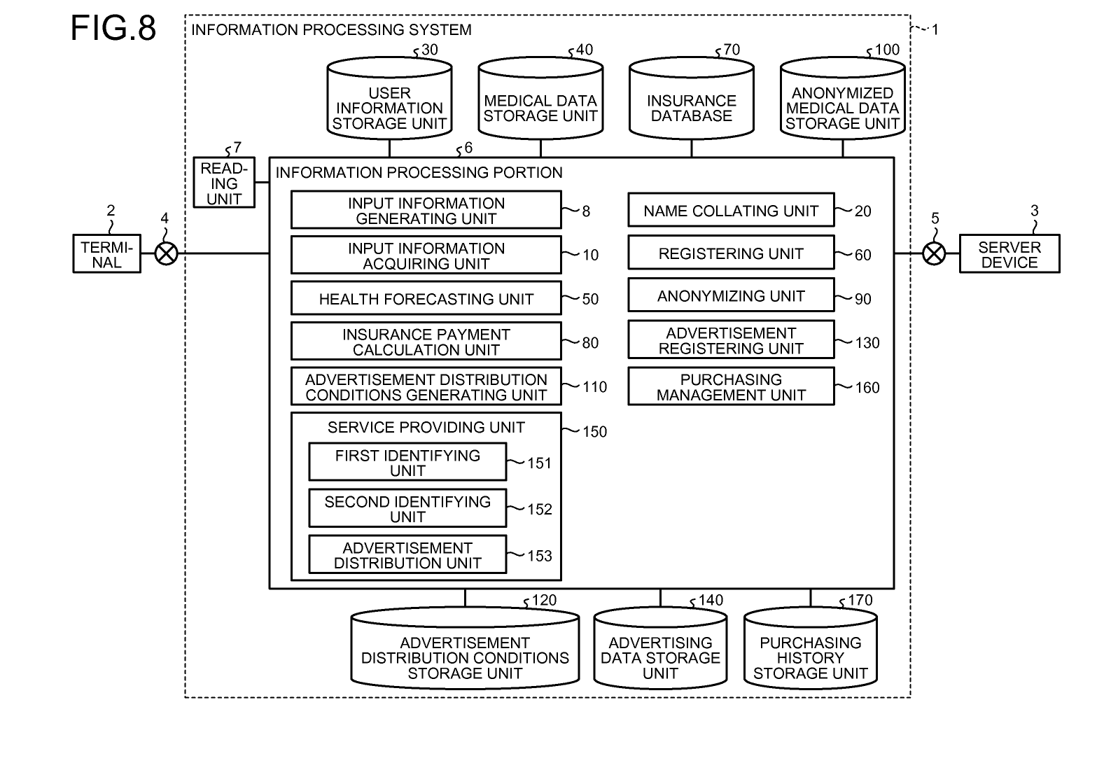

The input information may be acquired in any manner. For example, a user submits a sheet on which medical data including a result of a medical check-up, a user ID for identifying the user, an e-mail address on the terminal 2 used by the user, an address of the user, and the like are described (this sheet may be submitted by mail, for example), and then the input information may be read from the submitted sheet. In this manner, as illustrated in FIG. 8, the information processing system 1 further includes a reading unit 7 coupled to the information processing portion 6, and the information processing portion 6 further includes an input information generating unit 8.

The reading unit 7 may be a multifunction peripheral including a scanner function, for example, and optically reads the sheet submitted by the user, and generates digital data (hereinafter it may be referred to as “read data”).

The read data generated by the reading unit 7 is input to the input information generating unit 8 that in turn generates input information based on the read data input from the reading unit 7. The input information acquiring unit 10 acquires the input information generated by the input information generating unit 8.

As described above, the input information acquiring unit 10 acquires the input information including the user information and the medical data on each user who has agreed with provision of its own medical data under the condition that the user can be provided with free medical insurance services.

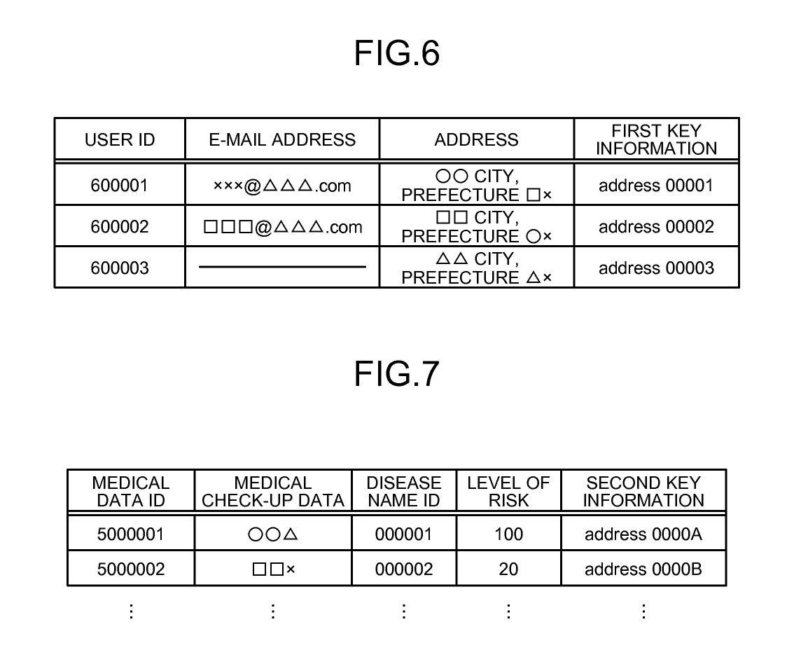

The explanation for FIG. 3 is continued. The name collating unit 20 executes processing for collating the descriptions of the input information acquired by the input information acquiring unit 10 (hereinafter it may be referred to as “name collation processing”). If the descriptions of the input information are unified in advance, the name collating unit 20 is not necessary. The user information that has been subjected to the name collation processing is associated with first key information that can be used for identifying the corresponding medical data, and then stored in the user information storage unit 30. In this example, the first key information can be used for identifying a location to which the medical data corresponding to the user information associated with the first key information is stored, in the later-described medical data storage unit 40. FIG. 6 is a diagram illustrating an example of information stored in the user information storage unit 30. As illustrated in FIG. 6, user information associated with first key information includes a user ID, an e-mail address on the terminal 2, an address, and first key information.

The medical data that has been subjected to the name collation processing is associated with second key information that can be used for identifying the corresponding user information and then stored in the medical data storage unit 40. In this example, the second key information can be used for identifying a location to which the user information corresponding to the medical data (medical check-up data) associated with the second key information is stored, in the user information storage unit 30. FIG. 7 is a diagram illustrating an example of information stored in the medical data storage unit 40. As illustrated in FIG. 7, medical information (medical check-up data) associated with second key information includes a medical data ID, medical check-up data identified by the medical data ID, a disease name ID, the level of risk, and second key information.

In this example, the user information and the medical data are stored in different storage units for ensuring sufficient security. This configuration is provided merely for exemplary purpose and not limiting, and the user information and the medical data may be associated with each other and stored in an identical storage unit, for example. In short, a first storage unit (one or more first storage units) is provided that stores therein the user information and the medical data in association with each other. In the example illustrated in FIG. 3, the user information storage unit 30 and the medical data storage unit 40 each can be thought to correspond to a “first storage unit” in claims herein. In this example, the user information storage unit 30 and the medical data storage unit 40 can also be thought to store therein user information including a user ID for identifying a target user to whom free medical insurance services are provided, and the medical data in association with each other.

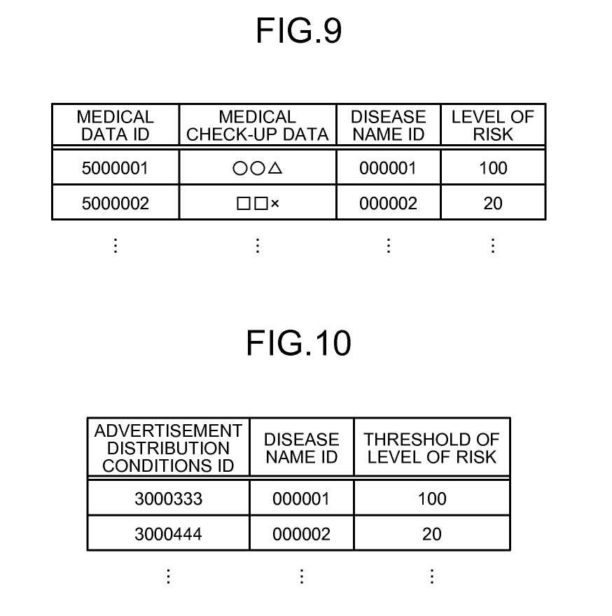

If the medical data stored in the medical data storage unit 40 is updated (including registration of new medical data), the health forecasting unit 50 calculates risk information indicating, for each of one or more diseases, the level of risk that represents the probability of occurrence of the disease based on the updated medical data. The health forecasting unit 50 then stores, in the medical data storage unit 40, the calculated risk information in association with the medical data. FIG. 9 is a diagram illustrating an example of information stored in the medical data storage unit 40. As illustrated in FIG. 9, the medical data storage unit 40 stores a medical data ID, the medical data identified by the medical data ID (e.g., various types of data such as a result of a medical check-up), and the risk information in association with one another. In the example illustrated in FIG. 9, a medical data ID indicating “5000001” is associated with medical data identified by the medical data ID, a disease name ID indicating “000001”, and risk information indicating the level of risk of the disease identified by the disease name ID (“100” in the example illustrated in FIG. 9). Although a case where one disease name ID and the level of risk of the disease identified by the disease name ID are associated as the risk information is exemplified in the example illustrated in FIG. 9 for convenience of description, it is not limited thereto and a plurality of disease name IDs and the levels of risk of the diseases identified by the respective disease name IDs may be associated.

The level of risk may be calculated using various publicly known technologies. For example, the level of risk may be calculated by using the prediction model of occurrence of various types of diseases in a study called “Hisayama study”. In this example, the health forecasting unit 50 can be thought to correspond to a “calculation unit” in claims herein.

The registering unit 60 registers a user identified by a user ID included in the input information acquired by the input information acquiring unit 10 as a target user to whom free medical insurance services are provided. In this example, the registering unit 60 registers as is the user ID included in the user information that has been subjected to the name collation processing as the information for identifying the target to whom free medical insurance services are provided, in the insurance database 70. The insurance payment calculation unit 80 reads a user ID registered in the insurance database 70 and reads the medical data and the risk information corresponding to the read user ID from the medical data storage unit 40, with reference to the user information storage unit 30 and the medical data storage unit 40. The insurance payment calculation unit 80 then determines the insurance amount based on the read risk information, and stores, in the insurance database 70, the determined insurance amount in association with the user ID.

The anonymizing unit 90 executes processing for anonymizing the medical data and the risk information stored in the medical data storage unit 40. For example, if the medical data includes unique information that can be used for identifying an individual by the medical data alone, the anonymizing unit 90 executes processing for excluding the medical data and the risk information associated with the medical data (hereinafter it may be referred to as “anonymizing processing”). The anonymizing unit 90 then stores, in the anonymized medical data storage unit 100, only the information not targeted for the anonymizing processing out of the medical data and the risk information stored in the medical data storage unit 40. This operation is provided merely for exemplary purpose and not limiting. The above-described anonymizing processing may not be executed (the anonymizing unit 90 and the anonymized medical data storage unit 100 are not provided), for example.

The advertisement distribution conditions generating unit 110 refers to medical data and risk information stored in the anonymized medical data storage unit 100, and stores, in the advertisement distribution conditions storage unit 120, the disease name ID (in this example, corresponding to “disease name identification information” in claims herein) included in the medical data and the risk information. The advertisement registering unit 130 determines a threshold (as later described, this will serve as conditions for distributing an advertisement of commodities or services relating to the disease identified by the disease name ID) of the level of risk corresponding to the disease name ID according to the indication by an advertiser (a business operator selling commodities concerning health or providing services concerning health) that receives advertisement services. The advertisement registering unit 130 then stores, in the advertisement distribution conditions storage unit 120, the determined threshold of the level of risk in association with the disease name ID. In this example, the advertiser inputs the indication information indicating the threshold of the level of risk corresponding to the disease name ID to the server device 3 that in turn transmits the indication information to the information processing system 1. The advertisement registering unit 130 determines the threshold of the level of risk corresponding to the disease name ID according to the indication information received from the server device 3. FIG. 10 is a diagram illustrating an example of information stored in the advertisement distribution conditions storage unit 120. As illustrated in FIG. 10, the advertisement distribution conditions storage unit 120 stores therein an advertisement distribution conditions ID used for identifying certain advertisement distribution conditions, the disease name ID, and the threshold of the level of risk in association with one another.

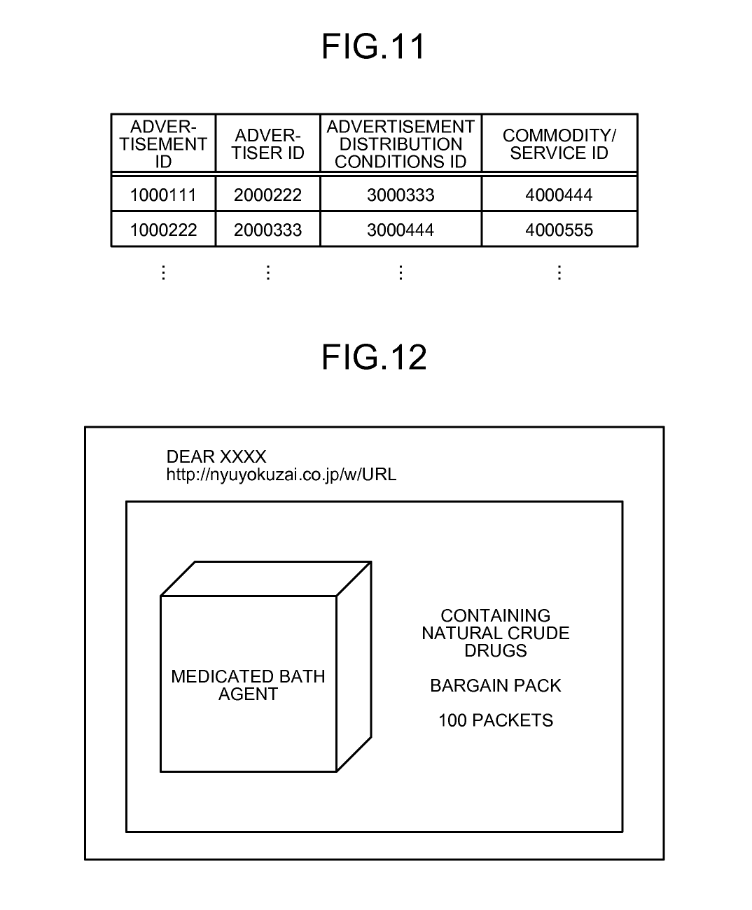

The explanation for FIG. 3 is continued. The advertisement registering unit 130 stores, in the advertising data storage unit 140, the information indicating the detailed advertisement according to the indication by the advertiser. In the same manner as described above, the advertiser inputs the indication information indicating the detailed advertisement to the server device 3 that in turn transmits the indication information to the information processing system 1. The advertisement registering unit 130 registers in the advertising data storage unit 140 the information indicating the detailed advertisement according to the indication information received from the server device 3. FIG. 11 is a diagram illustrating an example of information stored in the advertising data storage unit 140. As illustrated in FIG. 11, the advertising data storage unit 140 stores therein the advertisement ID used for identifying the advertisement of commodities sold or services provided by the advertiser (in this example, corresponding to “advertisement identification information” in claims herein), the advertiser ID used for identifying the advertiser, the advertisement distribution conditions ID, and a commodity/service ID used for identifying commodities concerning health or services concerning health (in this example, corresponding to “commodity/service identification information” in claims herein) in association with one another.

Alternatively, one storage unit may be provided in which the advertisement distribution conditions storage unit 120 and the advertising data storage unit 140 are integrated with each other. In short, a second storage unit (one or more second storage units) is provided that stores therein the advertisement identification information (in this example, the advertisement ID) used for identifying the advertisement of commodities sold or services provided by the business operator, the disease name identification information (in this example, the disease name ID) used for identifying the disease, and the threshold of the level of risk associated with one another. In the example illustrated in FIG. 3, the advertisement distribution conditions storage unit 120 and the advertisement data storage unit 140 each can be thought to correspond to a “second storage unit” in claims herein.

The service providing unit 150 illustrated in FIG. 3 provides a second service utilizing the user information and the medical data to a business operator selling commodities concerning health or providing services concerning health (an advertiser). In this example, the second service is an advertisement service in which the advertisement of commodities sold or services provided by the business operator is distributed to a user (the insured person). This is provided merely for exemplary purpose and not limiting.

As illustrated in FIG. 3, the service providing unit 150 includes a first identifying unit 151, a second identifying unit 152, and an advertisement distribution unit 153. The first identifying unit 151 identifies the medical data associated with the risk information indicating that the level of risk of the disease identified by the disease name ID associated with the advertisement ID targeted for the distribution has a value equal to or larger than the threshold of the level of risk associated with the advertisement ID out of a plurality of medical data stored in the medical data storage unit 40.

The second identifying unit 152 identifies the user information associated with the medical data identified by the first identifying unit 151. In this example, the second identifying unit 152 identifies the second key information associated with the medical data identified by the first identifying unit 151 out of pieces of the second key information stored in the medical data storage unit 40. The second identifying unit 152 identifies the user information stored in the location indicated by the identified second key information out of the user information storage unit 30 as the user information associated with the medical data identified by the first identifying unit 151.

The advertisement distribution unit 153 distributes the advertisement identified by the distribution target advertisement ID to the user identified by the user ID included in the user information identified by the second identifying unit 152. In this example, the advertisement distribution unit 153 transmits an advertisement e-mail including description of a link destination of a page displaying the advertisement identified by the distribution target advertisement ID to the destination of an e-mail address included in the user information identified by the second identifying unit 152. In this example, the advertisement distribution unit 153 generates the advertisement e-mail based on the commodity/service ID associated with the distribution target advertisement ID. FIG. 12 is a diagram illustrating an example of an advertisement distributed to a user by e-mail. As illustrated in FIG. 12, an advertisement for a medicated bath agent is distributed to a user (Dear xxxx). When an interested user clicks on the URL (link destination), the user is guided to a Web site providing more detailed descriptions, where the user can purchase the item.

If the user (the insured person) clicks the link destination described in the advertisement e-mail illustrated in FIG. 12 received through the terminal 2 used by the user itself, the user is guided to a sales site (assuming a Web site in this example) provided by the purchasing management unit 160. After the purchasing management unit 160 receives a purchase request of a commodity from the user through the sales site, the purchasing management unit 160 stores the purchase history in the purchasing history storage unit 170. The purchasing management unit 160 then notifies the server device 3 used by the advertiser, of the purchase request. In this example, the advertiser that has received the notification of the purchase request will pay a part of the sales amount of the commodity as the consideration for the advertisement service. The payment receiving unit 180 receives the payment from the advertiser. In this example, the payment receiving unit 180 can be thought to correspond to a “consideration acquiring unit” in claims herein.

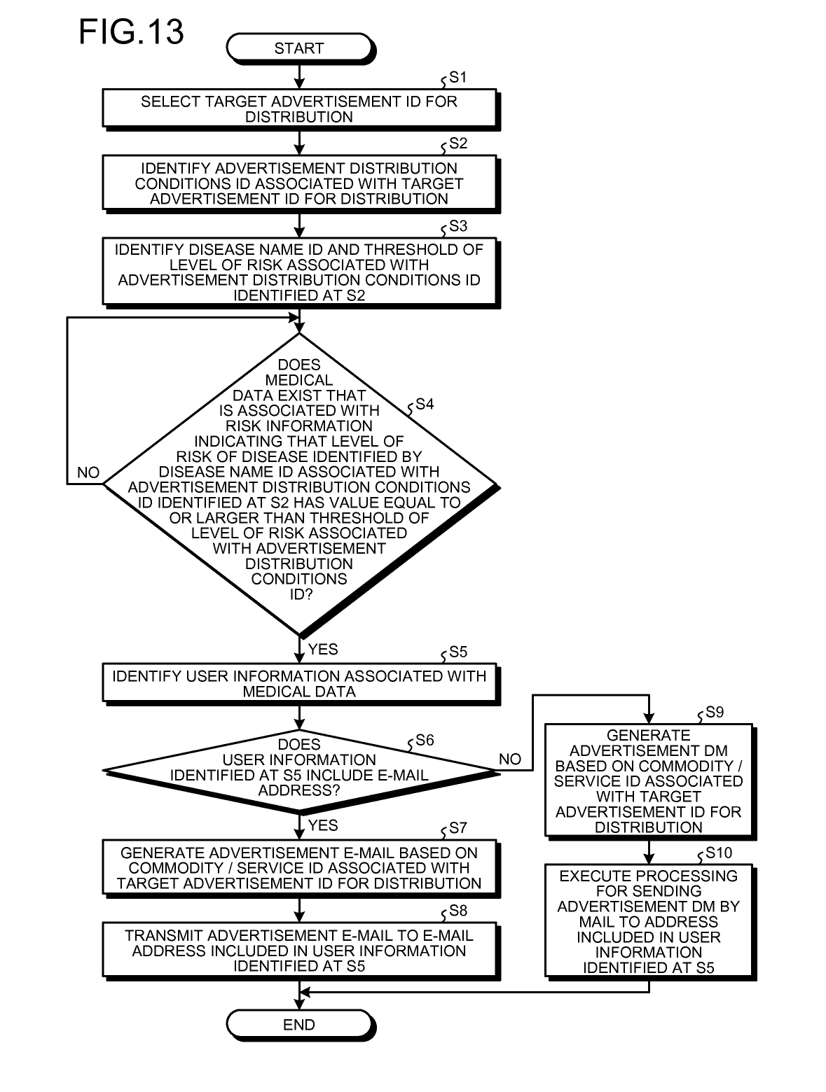

FIG. 13 is a flowchart illustrating an example of operations of the information processing system 1 providing advertisement services. Firstly, the first identifying unit 151 selects any advertisement ID out of the advertisement IDs stored in the advertising data storage unit 140, as a distribution target advertisement ID (Step S1). The distribution target advertisement ID may be selected in any manner. For example, the advertisement IDs stored in the advertising data storage unit 140 may be selected from the top in the descending order sequentially.

Subsequently, the first identifying unit 151 identifies the advertisement distribution conditions ID associated with the distribution target advertisement ID identified at Step S1 with reference to the advertising data storage unit 140 (Step S2). The first identifying unit 151 then identifies the disease name ID and the threshold of the level of risk associated with the advertisement distribution conditions ID identified at Step S2 with reference to the advertisement distribution conditions storage unit 120 (Step S3).

Subsequently, the first identifying unit 151 determines whether the medical data exists that associated with the risk information indicating that the level of risk of the disease identified by the disease name ID associated with the advertisement distribution conditions ID identified at Step S2 has a value equal to or larger than the threshold of the level of risk associated with the advertisement distribution conditions ID, with reference to the medical data storage unit 40 (Step S4). If the result at Step S4 is negative (No at Step S4) and if a plurality of combinations of the disease name ID and the threshold of the level of risk associated with the advertisement distribution conditions ID identified at Step S2 exist, the determination at Step S4 is executed on other combinations. If the result at Step S4 is negative (No at Step S4) and if only one combination of the disease name ID and the threshold of the level of risk associated with the advertisement distribution conditions ID identified at Step S2 exists, the process sequence returns to Step S1 and the subsequent distribution target advertisement ID is selected.

On the other hand, if the result at Step S4 is positive (Yes at Step S4), the first identifying unit 151 identifies the medical data associated with the risk information indicating that the level of risk of the disease identified by the disease name ID associated with the advertisement distribution conditions ID identified at Step S2 has a value equal to or larger than the threshold of the level of risk associated with the advertisement distribution conditions ID. The second identifying unit 152 identifies the user information associated with the medical data identified by the first identifying unit 151 with reference to the user information storage unit 30 and the medical data storage unit 40 (Step S5).

Subsequently, the advertisement distribution unit 153 checks whether the user information identified at Step S5 includes an e-mail address (Step S6). If the result at Step S6 is positive (Yes at Step S6), the advertisement distribution unit 153 generates an advertisement e-mail based on the commodity/service ID associated with the advertisement ID targeted for distribution with reference to the advertising data storage unit 140 (Step S7). The advertisement distribution unit 153 then transmits the advertisement e-mail to the e-mail address included in the user information identified at Step S5 (Step S8).

On the other hand, if the result at Step S6 is negative (No at Step S6), the advertisement distribution unit 153 generates an advertisement direct mail (DM) based on the commodity/service ID associated with the advertisement ID targeted for distribution with reference to the advertising data storage unit 140 (Step S9). Subsequently, the advertisement distribution unit 153 executes processing for sending the advertisement DM by mail to the address included in the user information identified at Step S5 (Step S10). Examples of the processing for sending the advertisement DM by mail include ordering processing for a delivery agent.

As described above, the mediation agent owing the information processing system 1 according to the present embodiment provides the user (the insured person) with free medical insurance services in exchange for the medical data of the user, thereby allowing a sufficient amount of the medical data to be collected. The mediation agent owing the information processing system 1 according to the present embodiment also provides a business operator selling commodities concerning health or providing services concerning health with an advertisement service for distributing the advertisement of commodities sold or services provided by the business operator to a user by utilizing the collected medical data, and acquires the consideration from the business operator, thereby allowing the cost of the medical insurance services to be covered. This operation can collect a sufficient amount of the medical data with lower cost and with high efficiency.

While an embodiment according to the present invention has been described, the present invention is not directly limited to the above-described embodiment. The present invention can be embodied by changing components without departing from the spirit and scope of the present invention when practiced. In addition, various aspects of the present invention can be made by properly combining the components of the above-described embodiment. For example, some components may be eliminated from all of the components in the above-described embodiment.

In the above-described embodiment, the mediation agent owing the information processing system 1 provides the user (the insured person) with free medical insurance services in exchange for the medical data of the user. This operation is described merely for exemplary purpose and not limiting. For example, the mediation agent may provide the user (the insured person) with medical insurance services with a benefit in exchange for the medical data of the user. Although a form of the benefit is arbitrary, examples of the benefit include admitting contract for fee-based medical insurance services although the state of health of the user makes it difficult to contract for typical medical insurance services. Examples of the benefit may also include discounting the charge of the medical insurance services, and providing specialized medical insurance services limited to an individual who provides its own medical data. On this occasion, the registering unit 60 registers a user identified by the user ID included in the input information acquired by the input information acquiring unit 10 as a target to whom a first service with a benefit (medical insurance services in this example) is provided. In addition, the user information storage unit 30 and the medical data storage unit 40 can also be thought to store user information including a user ID for identifying a target user to whom the medical insurance services with a benefit are provided, and the medical data in association with each other.

For another example, the information processing system 1 may include a first storage unit (one or more first storage units) that stores therein the user information, the medical data, and the flag information indicating whether the user is a target for providing free medical insurance services (or medical insurance services with a benefit) associated with one another rather than including the input information acquiring unit 10 or the registering unit 60 described above. The flag information indicating that the user is a target for providing free medical insurance services (or medical insurance services with a benefit) is associated with a user ID for identifying the user (the insured person) who has agreed with provision of its own medical data under the condition that the user can be provided with free medical insurance services (or medical insurance services with a benefit).

Also on this occasion, if the medical data stored in the first storage unit is updated, the health forecasting unit 50 calculates the risk information indicating the level of risk that represents the probability of occurrence of the disease for each of one or more diseases based on the updated medical data. The health forecasting unit 50 then stores, in the first storage unit, the calculated risk information in association with the medical data. In addition, the first identifying unit 151 identifies the medical data associated with the risk information indicating that the level of risk of the disease identified by the disease name ID associated with the advertisement ID targeted for the distribution has a value equal to or larger than the threshold of the level of risk associated with the advertisement ID out of a plurality of medical data stored in the first storage unit and are each associated with the flag information indicating that the user is a target for providing medical insurance services.

The computer program executed by the information processing system 1 according to the above-described embodiment may be provided in a manner recorded as an installable or executable file format on a computer-readable recording medium, such as a compact disc read-only memory (CD-ROM), a flexible disk (FD), a compact disc recordable (CD-R), a digital versatile disc (DVD), and a universal serial bus (USB). In addition, the computer program executed by the information processing system 1 according to the above-described embodiment may be provided or distributed over a network such as the Internet. Furthermore, the computer program may also be provided in a manner embedded in a non-volatile memory such as a read only memory (ROM), for example.

According to an embodiment, a sufficient amount of medical data can be collected with lower cost and with high efficiency.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system, comprising:
an input information acquiring unit that acquires input information including user information that includes user identification information for identifying a user, and medical data that indicates a state of health of the user;
a registering unit that registers the user identified by the user identification information included in the input information as a target for providing a free first service;
a first storage unit that stores therein the user information and the medical data in association with each other;
a service providing unit that provides a second service utilizing the user information and the medical data to a business operator selling commodities concerning health or providing services concerning health; and
a consideration acquiring unit that acquires a consideration for the second service from the business operator.

2. The information processing system according to claim 1, further comprising:
a calculation unit that calculates risk information indicating, for each of one or more diseases, a level of risk representing a probability of occurrence of the disease based on the medical data, and stores, in the first storage unit, the calculated risk information in association with the medical data; and
a second storage unit that stores therein advertisement identification information used for identifying an advertisement of commodities sold or services provided by the business operator, disease name identification information used for identifying a disease, and a threshold of the level of risk, in association with one another, wherein
the service providing unit comprises:
a first identifying unit that identifies the medical data associated with the risk information indicating that the level of risk of a disease identified the disease name identification information associated with the advertisement identification information has a value equal to or larger than the threshold of the level of risk associated with the advertisement identification information, out of a plurality of medical data stored in the first storage unit;
a second identifying unit that identifies the user information associated with the medical data identified by the first identifying unit; and
an advertisement distribution unit that distributes the advertisement identified by the advertisement identification information to the user identified by the user identification information included in the user information identified by the second identifying unit.

3. The information processing system according to claim 2, wherein
the user information includes an e-mail address of the user identified by the user identification information, and
the advertisement distribution unit transmits an advertisement e-mail including description of a link destination of a page displaying the advertisement identified by the advertisement identification information, to an e-mail address, as a destination, included in the user information identified by the second identifying unit.

4. The information processing system according to claim 3, wherein
the second storage unit stores therein the advertisement identification information, the disease name identification information, and commodity/service identification information used for identifying commodities concerning health or services concerning health, in association with one another, and
the advertisement distribution unit generates the advertisement e-mail based on the commodity/service identification information associated with the advertisement identification information.

5. The information processing system according to claim 1, wherein the medical data includes at least one of information indicating a result of a medical check-up, information indicating a medical certificate written by a doctor, information indicating a case history of the user, information indicating a case history of members of the user's family, information indicating hospital records, information indicating a medication history, information indicating a receipt serving as a health insurance claim form, and vital data including blood pressure, weight, and height.

6. The information processing system according to claim 2, wherein the medical data includes at least one of information indicating a result of a medical check-up, information indicating a medical certificate written by a doctor, information indicating a case history of the user, information indicating a case history of members of the user's family, information indicating hospital records, information indicating a medication history, information indicating a receipt serving as a health insurance claim form, and vital data including blood pressure, weight, and height.

7. The information processing system according to claim 3, wherein the medical data includes at least one of information indicating a result of a medical check-up, information indicating a medical certificate written by a doctor, information indicating a case history of the user, information indicating a case history of members of the user's family, information indicating hospital records, information indicating a medication history, information indicating a receipt serving as a health insurance claim form, and vital data including blood pressure, weight, and height.

8. The information processing system according to claim 4, wherein the medical data includes at least one of information indicating a result of a medical check-up, information indicating a medical certificate written by a doctor, information indicating a case history of the user, information indicating a case history of members of the user's family, information indicating hospital records, information indicating a medication history, information indicating a receipt serving as a health insurance claim form, and vital data including blood pressure, weight, and height.

9. The information processing system according to claim 1, wherein the first service is a medical insurance service.

10. The information processing system according to claim 4, wherein the first service is a medical insurance service.

11. An information processing system, comprising:
an input information acquiring unit that acquires input information including user information that includes user identification information for identifying a user, and medical data that indicates a state of health of the user;
a registering unit that registers the user identified the user identification information included in the input information as a target for providing a first service with a benefit;
a first storage unit that stores the user information and the medical data in association with each other;
a service providing unit that provides a second service utilizing the user information and the medical data to a business operator selling commodities concerning health or providing services concerning health; and
a consideration acquiring unit that acquires a consideration for the second service from the business operator.

12. The information processing system according to claim 11, further comprising:
a calculation unit that calculates risk information indicating, for each of one or more diseases, a level of risk representing a probability of occurrence of the disease based on the medical data, and stores, in the first storage unit, the calculated risk information in association with the medical data; and
a second storage unit that stores therein advertisement identification information used for identifying an advertisement of commodities sold or services provided by the business operator, disease name identification information used for identifying a disease, and a threshold of the level of risk, in association with one another, wherein
the service providing unit comprises:
a first identifying unit that identifies the medical data associated with the risk information indicating that the level of risk of a disease identified by the disease name identification information associated with the advertisement identification information has a value equal to or larger than the threshold of the level of risk associated with the advertisement identification information, out of a plurality of medical data stored in the first storage unit;
a second identifying unit that identifies the user information associated with the medical data identified by the first identifying unit; and
an advertisement distribution unit that distributes the advertisement identified by the advertisement identification information to the user identified by the user identification information included in the user information identified by the second identifying unit.

13. The information processing system according to claim 12, wherein
the user information includes an e-mail address of the user identified by the user identification information, and
the advertisement distribution unit transmits an advertisement e-mail including description of a link destination of a page displaying the advertisement identified by the advertisement identification information, to an e-mail address, as a destination, included in the user information identified by the second identifying unit.

14. The information processing system according to claim 13, wherein
the second storage unit stores therein the advertisement identification information, the disease name identification information, and commodity/service identification information used for identifying commodities concerning health or services concerning health, in association with one another, and
the advertisement distribution unit generates the advertisement e-mail based on the commodity/service identification information associated with the advertisement identification information.

15. The information processing system according to claim 11, wherein the medical data includes at least one of information indicating a result of a medical check-up, information indicating a medical certificate written by a doctor, information indicating a case history of the user, information indicating a case history of members of the user's family, information indicating hospital records, information indicating a medication history, information indicating a receipt serving as a health insurance claim form, and vital data including blood pressure, weight, and height.

16. The information processing system according to claim 12, wherein the medical data includes at least one of information indicating a result of a medical check-up, information indicating a medical certificate written by a doctor, information indicating a case history of the user, information indicating a case history of members of the user's family, information indicating hospital records, information indicating a medication history, information indicating a receipt serving as a health insurance claim form, and vital data including blood pressure, weight, and height.

17. The information processing system according to claim 13, wherein the medical data includes at least one of information indicating a result of a medical check-up, information indicating a medical certificate written by a doctor, information indicating a case history of the user, information indicating a case history of members of the user's family, information indicating hospital records, information indicating a medication history, information indicating a receipt serving as a health insurance claim form, and vital data including blood pressure, weight, and height.

18. The information processing system according to claim 14, wherein the medical data includes at least one of information indicating a result of a medical check-up, information indicating a medical certificate written by a doctor, information indicating a case history of the user, information indicating a case history of members of the user's family, information indicating hospital records, information indicating a medication history, information indicating a receipt serving as a health insurance claim form, and vital data including blood pressure, weight, and height.

19. The information processing system according to claim 11, wherein the first service is a medical insurance service.

20. The information processing system according to claim 14, wherein the first service is a medical insurance service.
